(19) United States
(12) Patent Application Publication
(10) Pub. No.: US 2002/0194583 A1
(43) Pub. Date: Dec. 19, 2002

(54) System and method for automatically transferring data to a host

(76) Inventor: Masayuki Kitagawa, Irivne, CA (US)

Correspondence Address: KNOBBE MARTENS OLSON & BEAR LLP, 2040 MAIN STREET, FOURTEENTH FLOOR, IRVINE, CA, 91614, US

(21) Appl. No.: 09/844,285

(22) Filed: Apr. 27, 2001

(51) Int. Cl. G06F 9/445

(52) U.S. Cl. 717/173; 717/178

(57) ABSTRACT

The invention is directed to a system and method where data is transferred to a host from a device or data source associated with the device. The device includes a non-volatile memory that stores Internet Website addresses or software to be used therewith. When the device is connected to the host, data or software is automatically transferred to the host from the memory or the data source of the Website addresses designated by the memory, without receiving instructions from a user.

### BACKGROUND OF THE INVENTION

1. Field of the Invention

The invention relates to a system and method for transferring data or software to a host from a device, and particularly to a system and method for automatically transferring data or software to a host from a device or data sources associated with the device.

2. Description of the Related Technology

Personal computers are widely used these days. So are printers. The personal computer is quite often connected with the printer. In this situation, the personal computer is called a host, while the printer is called a device (also called “peripheral”).

FIG. 1 illustrates a system where a host 11 is connected with a device 12 via a connector 13 in the prior art. The host also includes Internet appliances, Web browsers, and digital image editors. The device further contains digital cameras and scanners. For clarity, it is assumed that the host 11 is a personal computer. The personal computer 11 can include a drive for CDs (Compact Discs) 14 and floppy discs 15 as shown in the figure. The device 12 comprises an internal non-volatile memory 16 that stores a device control logic such as a firmware controlling device or an ASIC (Application Specific IC). The size of the memory 16 may range from 256 Kbyte to 4 Mbyte. The device controlling logic, which can be either software or hardware, controls a basic operation of the device 12, and is installed at a factory before shipment. The connector 13 may be a USB (Universal Serial Bus), an IEEE 1394, or an SCSI (Small Computer System Interface).

FIG. 2 is a flowchart illustrating the operation of the system shown in FIG. 1. It is assumed that the connector 13 is configured according to the USB standard. FIG. 2 comprises FIG. 2A and FIG. 2B. FIG. 2A is a flowchart by which device driver is installed. FIG. 2B is a flowchart by which application is installed.

The device driver is one kind of software that drives the device 12 itself. The application software (also called “application”) is one that, when the device 12 is a scanner, for example, enlarges or reduces images the scanner has read, or one that, when the device 12 is a digital camera, edits pictures the digital camera has taken. The device driver and application software may be stored in CDs 14 and/or floppy discs 15.

At state 200, a host, the computer 11 in this case, is turned on for start-up. At state 201, the computer 11 decides whether the device 12 is connected. If it is connected, the sequence goes to state 202 where the computer 11 checks the information on the device 12. If at state 201 the device 12 is not connected, at state 203 the computer 11 decides that no device is connected and exits this sequence.

After checking the information at state 202, the sequence proceeds to state 204 where the computer 11 determines whether the device driver for the device 12 is already available in the host system. If it is not available, at state 205 the computer 11 asks a user to load therein media (CD-ROM or floppy disc) storing the device driver.

Then, at state 206, the computer 11 determines whether the device driver is stored in the loaded media. If it is stored, the sequence goes to state 207 where the computer 11 gets the device driver from the media. If, on the other hand, at state 206, the device driver is not stored on the media, at state 208 the computer 11 asks the user to cancel the loading of the device driver. Next, at state 209, the computer 11 determines whether the user has canceled the device driver load. If it is decided that the user has, at state 210 the computer 11 decides that a device is connected, but the device driver is unavailable. If, at state 209, it is decided that the user has not, the flow returns back to state 205.

At state 204 when it is decided that the device driver is available, and at state 209 when the computer 11 gets the device driver from the media, both satisfied conditions cause the execution of control to proceed to state 220 in FIG. 2B through a symbol CH1. At state 220, the computer 11 decides whether an application is already available in the host system. If it decides that it is not, the flow goes to state 221 where the computer 11 asks the user to load the media storing the application. At state 222, the computer 11 decides whether the application is available in the loaded media. If the computer 11 decides that it is, at state 223 the computer 11 retrieves the application from the media, and then at state 224 decides that the device is connected, and the device driver and application are available.

If at state 220 it is decided that the application is available, the procedure jumps to state 224 where the processing takes place as described above.

If at state 222 it is decided that the application is not available on the media, the sequence goes to state 225 where the computer 11 asks the user to cancel the loading of the application. At state 226, the computer 11 determines whether the user has canceled the application loading. If it is determined that the user has, at state 227 the computer 11 decides that the device is connected, but the application is unavailable. If at state 226 it is determined that the user has not, the sequence goes back to state 221 and proceeds as discussed above.

FIG. 3 is a flowchart illustrating the operation of a firmware controlling the device 12, as one of the examples of a device control logic, in the prior art. First, at state 30, the device 12 is powered on. Then, at state 31, the functions of the device 12 are initialized. At state 32, it is decided whether commands are received from the host 11. If it is decided that they are, the sequence goes to state 33 where the operations of the device 12 are performed according to the commands. At state 34, routine work of the device 12 is done. Then, the sequence returns to state 32. If at state 32 it is decided that the commands are not received, the sequence jumps to state 34 and processing continues the loop as described above.

For the device driver and application that are stored in the media such as the CDs 14 or floppy discs 15, the user has to manually load them into the personal computer 11 and perform some operations on the personal computer 11 to start the device driver or application. This seems to be time-consuming and troublesome to the user.

The device 12 may be accompanied by a user's manual at the time purchase. The manual is supplied in the form of paper or media. Once a user consults the manual, he/she misplaces the manual and sometimes cannot locate it when needed. This is a stressful situation.

The personal computer 11 is quite often used to get some information or update some software regarding the device 12 from Websites on the Internet. The user has to manually enter the addresses for the Websites into the personal computer 11 each time he accesses the Websites. It is time-consuming and burdensome for the user.

As mentioned above, the system shown in FIG. 1 gives rise to inconveniences such as being time-consuming, stressful or burdensome. Accordingly, there is a need to limit inconvenience and realize a system that provides users with user-friendliness and case of operation.

### SUMMARY OF CERTAIN INVENTIVE ASPECTS

The present invention is directed to a system and method that satisfy the need.

One aspect of the invention relates to the method that transfers data or software to a host from or through a device with a memory. The method comprises storing in the memory at least one data or software and at least one address that designates its corresponding data source; connecting the host to the device; allowing the host to inquire of the device whether or not a desired data or software is stored in the memory; and if so, uploading the desired data or software to the host from the memory.

Another aspect of the invention relates to the method that transfers data or software to a host from or through a device with a memory. The method comprises storing in the memory at least one data or software and at least one address that designates its corresponding data source; connecting the host to the device; allowing the host to inquire of the device driver whether or not a desired data or software is available from the data source via the address; and if so, downloading the desired data or software to the host from the data source.

Still another aspect of the invention relates to the method that transfers data or software to a host through a device with a memory. The method comprises storing in the memory at least one address that designates its corresponding data source; connecting the host to the device; allowing the host to inquire of the device whether or not a desired data or software is available from the data source via the address; and if so, downloading the desired data or software to the host from the data source.

Further still another aspect of the invention relates to the system that transfers data or software. The system comprises a host; a device, having a memory, connected to the host, wherein the memory stores at least one data or software and at least one address that designates its corresponding data source; whereby the host inquires of the device whether or not a desired data or software is stored in the memory, and if so, uploads the desired data or software to the host from the memory.

Another aspect of the invention relates to the system that transfers data or software. The system comprises a host; a device, having a memory, connected to the host, wherein the memory stores at least one data or software and at least one address that designate its corresponding data source; whereby the host inquires of the device whether or not a desired data or software is available from the data source, and if so, downloads the desired data or software to the host from the data source.

Still another aspect of the invention relates to the system that transfers data or software. The system comprises a host; a device, having a memory, connected to the host, wherein the memory stores at least one address that designates its corresponding data source; whereby the host inquires of the device whether or not a desired data or software is available from the data source via the address, and if so, downloads the desired data or software to the host from the data source.

### BRIEF DESCRIPTION OF THE DRAWINGS

These and other features of the invention will now be described with reference to the drawings summarized below. These drawings and the associated description are provided to illustrate preferred embodiments of the invention, and not to limit the scope of the invention.

FIG. 1 illustrates a system where a host is connected with a device via a connector in the prior art.

FIG. 2 is a flowchart illustrating the operation of the system shown in FIG. 1.

FIG. 3 is a flowchart illustrating the operation of a firmware program controlling a device according to the system show in FIG. 1.

FIG. 4 illustrates a first embodiment of a system where a host is connected with a device via a connector in accordance with the invention.

FIG. 5 illustrates a second embodiment of a system where a host is connected with a device via a connector in accordance with the invention.

FIG. 6 is a flowchart illustrating the operation of the system when a host is connected to a device, with respect to obtaining a device driver and an application, in accordance with the invention.

FIG. 7 is a flowchart illustrating the operation of the system when a host is connected to a device, with respect to obtaining user's manual, in accordance with the invention.

FIG. 8 is a flowchart illustrating the operation of the system when a host is connected to a device, with respect to updating a device driver, in accordance with the invention.

FIG. 9 is a flowchart illustrating the operation of the system when a host is connected to a device, with respect to updating an application, in accordance with the invention.

FIG. 10 is a flowchart illustrating the operation of the system when a host is connected to a device, with respect to updating an user's manual, in accordance with the invention.

FIG. 11 is a flowchart illustrating the operation of a firmware prgram controlling a device for storing only Internet Website addresses in accordance with the invention.

FIG. 12 is a flowchart illustrating the operation of a firmware controlling device for storing Internet Website addresses, device driver, application, and user's manual in accordance with the invention.

### DETAILED DESCRIPTION OF CERTAIN INVENTIVE EMBODIMENTS

Although this invention will be described in terms of certain embodiments, other embodiments that are apparent to those skilled in the art, are also within the scope of the invention.

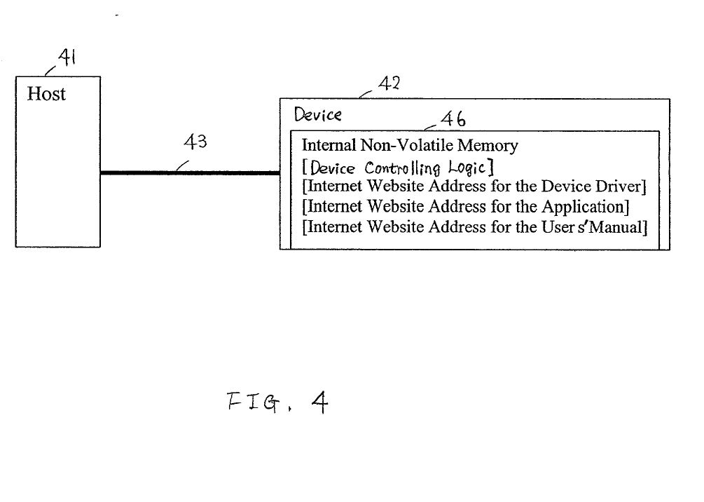

FIG. 4 illustrates a first embodiment of a system where a host is connected with a device via a connector in accordance with the invention. Referring to the figure, a host 41 is connected to a device 42 by a connector 43. The device 42 includes an internal non-volatile memory 46.

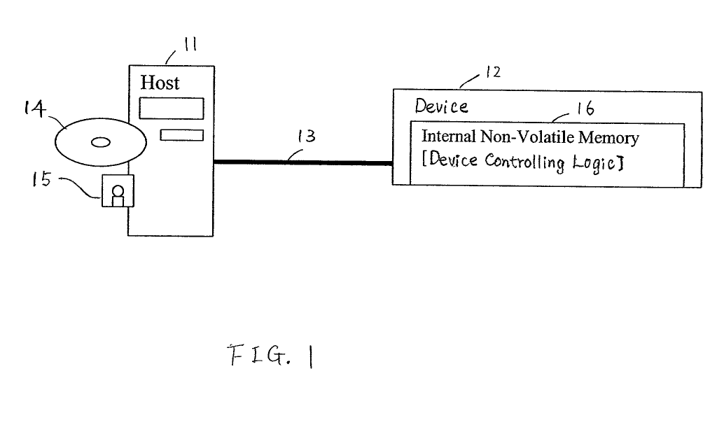

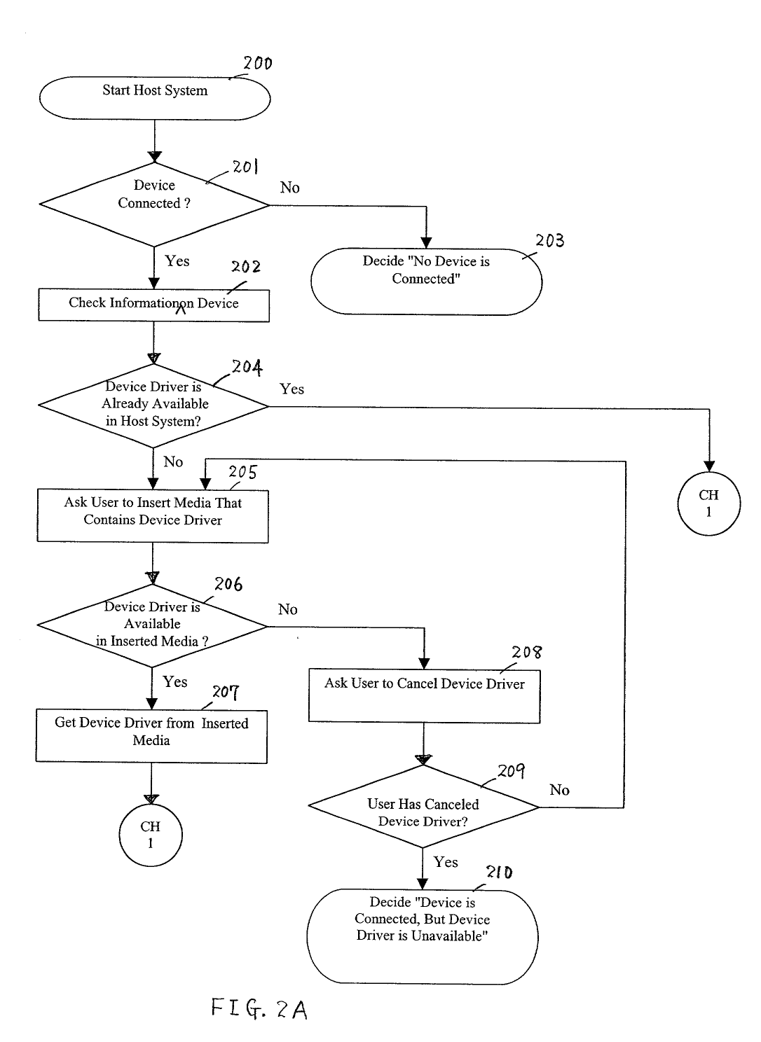

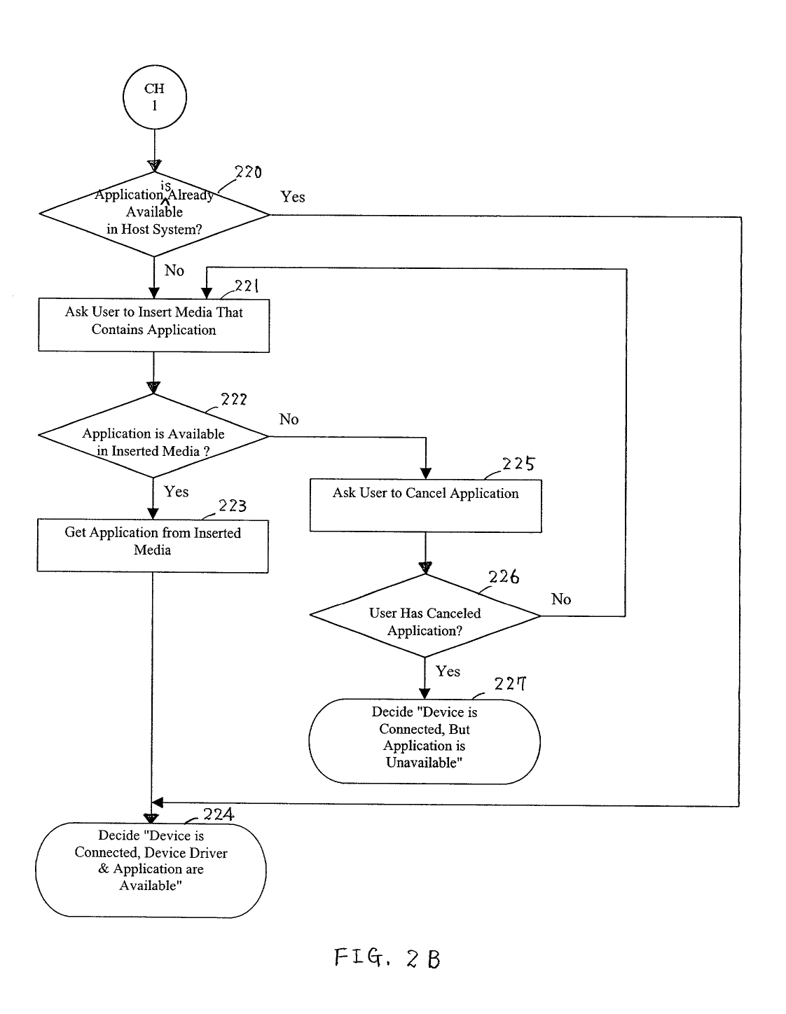

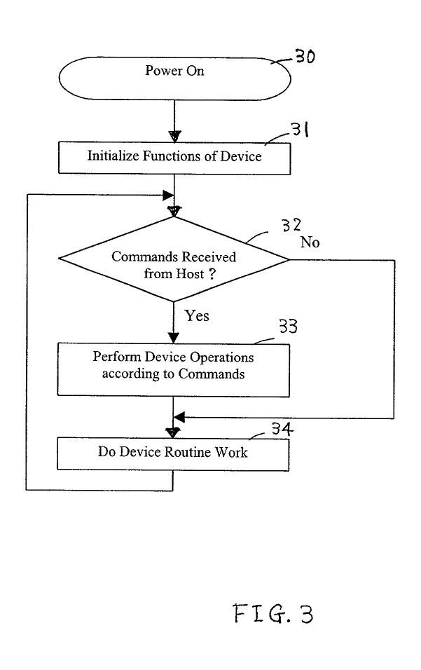

The system shown in FIG. 4 has the same elements as those of the system shown in FIG. 1. The host 41 is the same as the host 11; the connector 43 is the same as the connector 13. The device 42 is basically the same as the device 12, except for the contents in the memories 16 and 46. This is the case in this and the following figures. Note that the components 41, 43, 42 and 46 are not limited to any one type of embodement.

In one embodiment, the memory 16 stores only the device control logic, while the memory 46 stores the Internet Website addresses in addition to the device control logic. The Internet Website addresses include, by way of example, the Internet Website addresses for the device driver, the application, and user's manual. Those addresses may be stored beforehand at a factory. In one embodiment, the memory 46 needs extra capacity of some 100 bytes for the Internet Website addresses, and 256 Kbytes to 4 Mbytes as a whole.

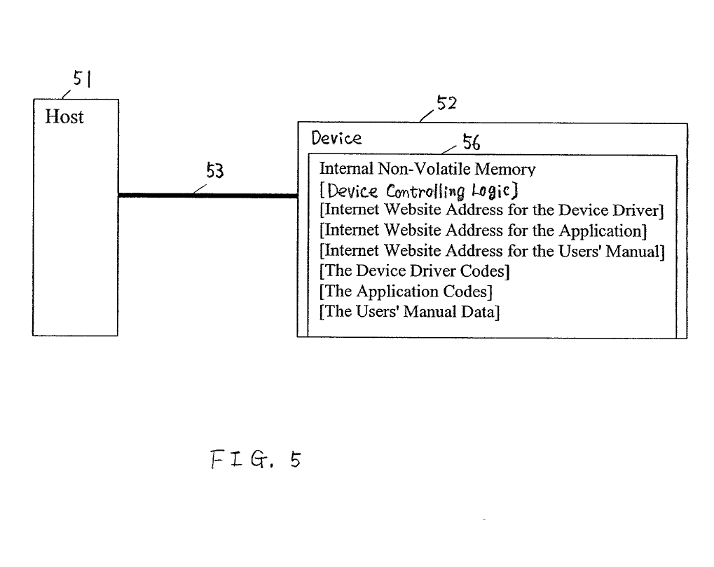

FIG. 5 illustrates a second embodiment of a system where a host is connected with a device via a connector in accordance with the invention. Referring to the figure, a host 51 is connected to a device 52 by a connector 53. The device 52 includes an internal non-volatile memory 56.

The system shown in FIG. 5 has the same elements as those of the system shown in FIG. 4. The host 51 is the same as the host 41; the connector 53 is the same as the connector 43. The device 52 is basically the same as the device 42, except for the contents in the memories 46 and 56. The memory 46 stores only the device control logic and the Internet Website addresses, whereas the memory 56 additionally stores the device drive codes, application codes, and user's manual data, which may be registered in a factory before shipment. The memory 56 needs large capacity for the additional e codes and data, and ranges, for example, approximately from 0.5 to 10 Mbytes as a whole.

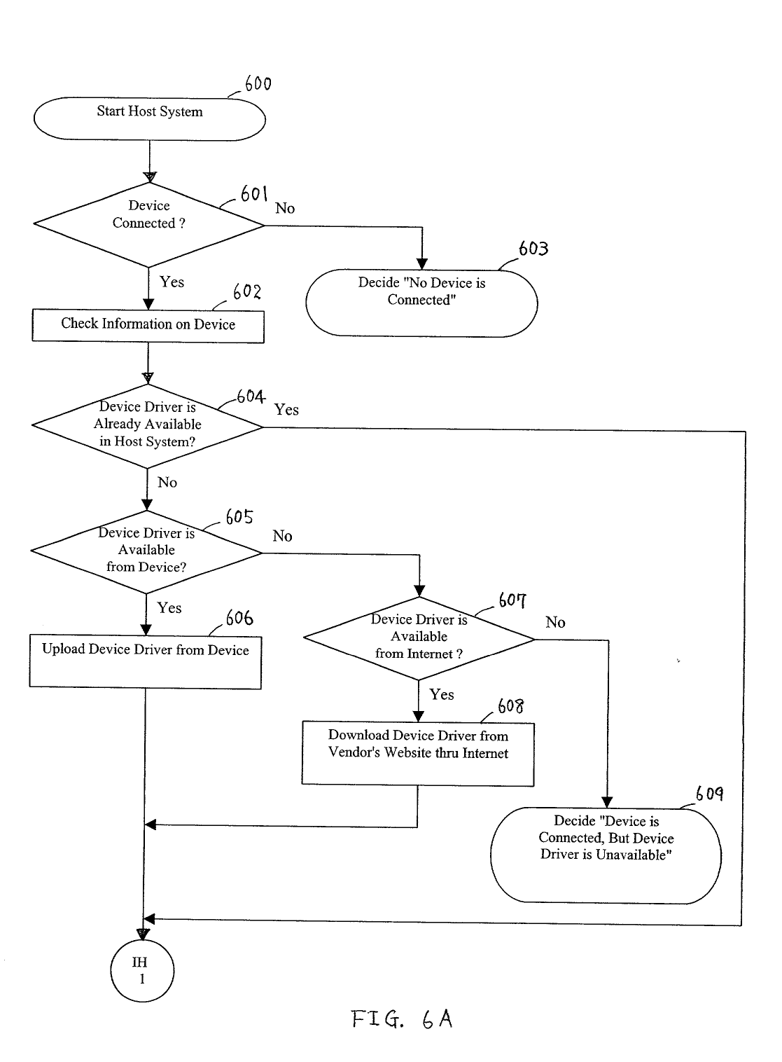

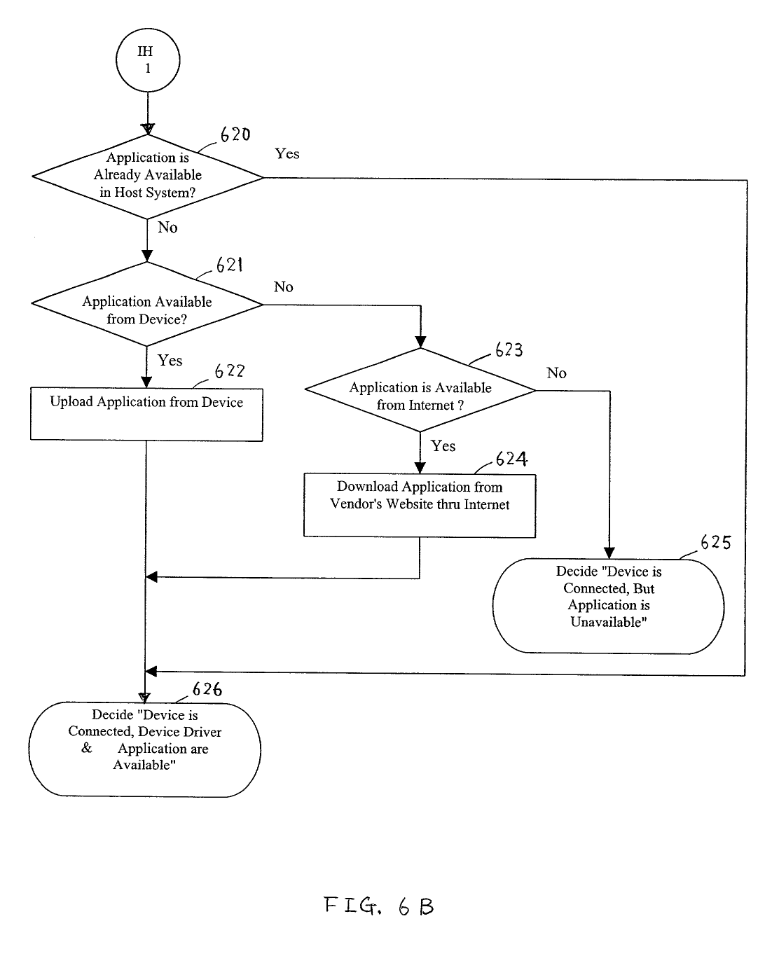

FIG. 6 is a flowchart illustrating the operation of the system when a host is connected to a device, with respect to obtaining a device driver and an application, in accordance with the invention. FIG. 6 comprises FIGS. 6A and 6B. FIG. 6A is directed to the device driver, while FIG. 6B is directed to the application. The flowchart can be explained by referring to the first and second embodiments shown in FIGS. 4 and 5. Since the structure of FIG. 5 is identical to that of Figure of 4 except for the contents stored in the non-volatile memories, the reference numerals shown in FIG. 5 are basically used to explain the operation of FIG. 6.

At state 600, the host 51, which may be a personal computer, is turned on to start. At state 601, the computer 51 decides whether the device 52 is connected. The decision is made by, for example, regularly monitoring an output or detecting only an interrupt. If the device 52 is connected, the sequence goes to state 602 where the computer 51 checks the information on the device 52. The check may be made, when the connector 53 is a USB, based on the format of the USB. If, on the contrary, it is not, at state 603 the computer 51 decides that no device is connected. After checking the information at state 602, the sequence proceeds to state 604 where the computer 51 determines whether device driver for the device 52 is already available in the host system. When some kind of device driver has been used before or has been stored already, it is decided that the device driver is available.

If at state 604 it is decided that the device driver is not available, the procedure goes to state 605 where the computer 51 asks the device 52 whether device driver is available from the device 52. One example of the codes the computer 51 uses for the asking is shown in Appendix 1. The example is implemented by using the USB. When it is decided at state 605 that the device driver is available as shown in FIG. 5, the sequence goes to state 606 where the computer 51 automatically uploads the device driver from the device 52. If at state 605 it is decided that the device driver is not available, the procedure goes to state 607 where the computer 51 asks the device 52 whether device driver is available from the Internet. When the Internet Website address for the device driver is known as shown in FIG. 4, the computer 51 accesses to a vendor's Website. Then, at state 608, the computer 51 downloads the device driver through the Internet.

Accordingly, since the computer 51 can download the device driver regularly or at the request of the user, the device driver may be updated quite often and the latest version of the device driver may be stored in the device 52. The latest device driver, as a result, can be always available to the user. If at state 607 it is decided that the device driver is not available, at state 609 the computer 51 decides that a device is connected, but the device driver is unavailable. In this case, the user has to manually download the device driver by loading media storing it, as in the prior art.

After states 606 and 608, and when at state 604 it is determined that the device driver is already available in the host system, the sequence goes to state 620 through a symbol IH1 to upload application. At state 620, the computer 51 decides whether the application is already available in the host system. When it is decided that the application is not available, the sequence goes to state 621 where the computer 51 asks the device 52 whether application is available from the device. When the application is available as shown in FIG. 5, at state 622 the computer 51 uploads the application from the device 52.

If at state 621 it is determined that the application is not available, the sequence proceeds to state 623 where the computer 51 asks the device 52 whether the application is available from the Internet. When the Internet Website address for the application is known as shown in FIG. 4, at state 625 the computer 51 accesses to a vendor's Website. Then, at state 624, the computer 51 downloads the application through the Internet. If at state 623 it is decided that the application is not available, the computer 51 decides that a device is connected, but the application is unavailable. In this case, the user has to manually download the application by loading media storing it, as in the prior art.

After states 622 and 624, and when at state 620 it is determined that application is already available in the host system, the sequence goes to state 626 where the computer 51 decides that a device is connected, and the device driver and application are available.

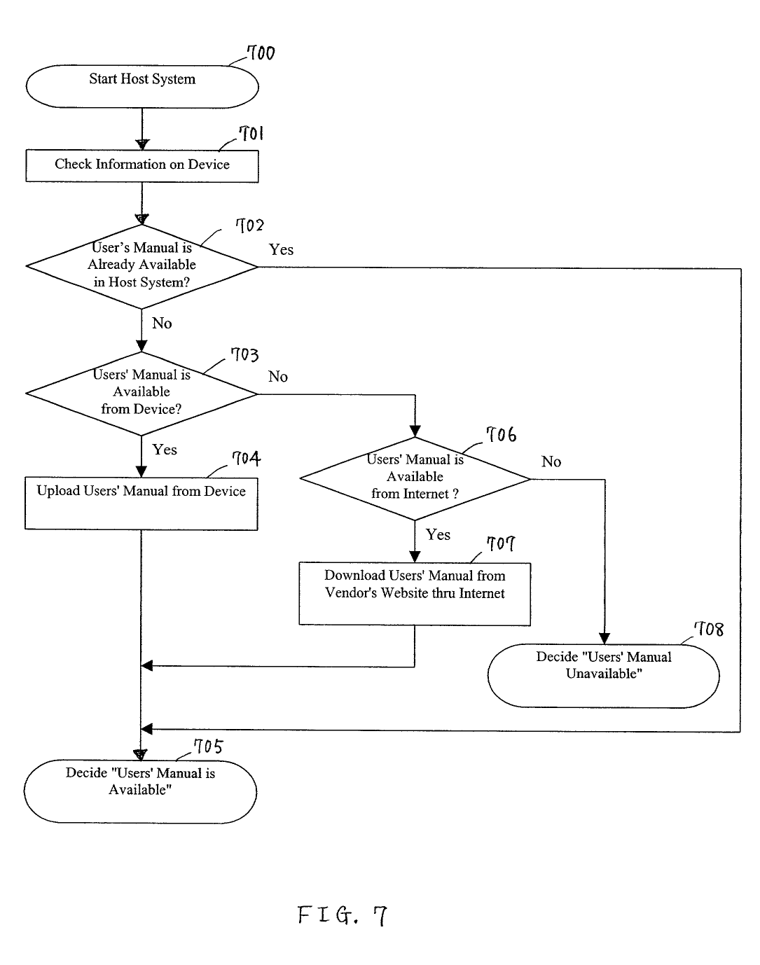

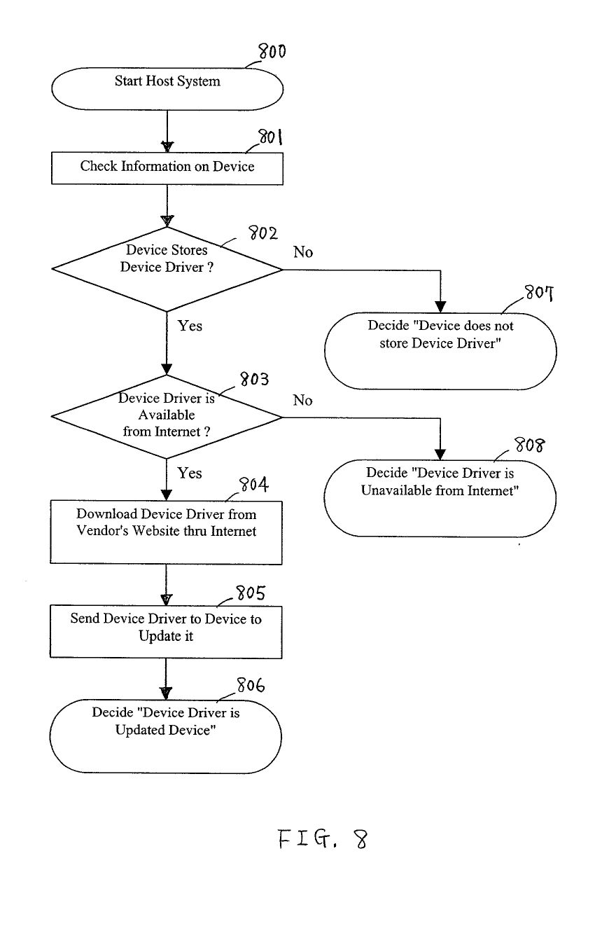

FIG. 7 is a flowchart illustrating the operation of the system when a host is connected to a device, with respect to obtaining user's manual, in accordance with the invention. The operation of states 700-708 is basically identical to that of states 600, 602, 604-609 and 626, respectively. The only difference is that FIG. 6 is directed to the device driver, while FIG. 7 relates to the user's manual. Accordingly, a discussion of the states in FIG. 7 may be omitted.

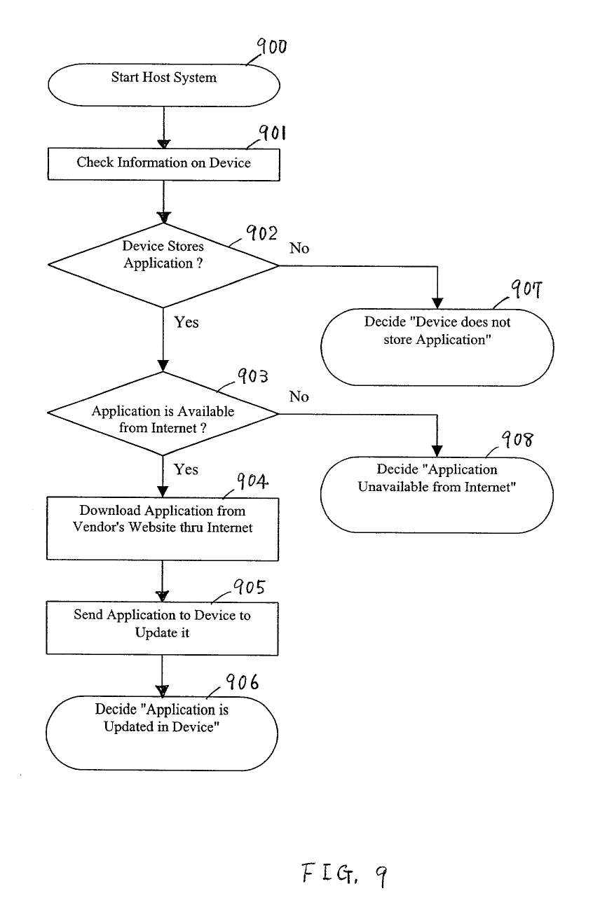

FIG. 8 is a flowchart illustrating the operation of the system when a host is connected to a device, with respect to updating the device driver, in accordance with the invention. The updating of software is necessary because the software is revised quite often to resolve problems therein or to add new features thereto.

At state 800, the personal computer 51 is turned on to start. At state 801, the computer 51 checks the information on the device 52. The check is done based on the format of the USB. After checking the information at state 801, the sequence proceeds to state 802 where the computer 51 asks the device 52 whether the device 52 stores a device driver. If at state 802 it is decided that the device 52 stores the device driver, the procedure goes to state 803. If on the contrary it is decided that it does not, the procedure goes to state 807 and the computer 51 decides that the device 52 does not stores device driver. In this case, the user has to either use the Internet Website address as in the first embodiment shown in FIG. 4, or download the device driver by loading media storing it as in the prior art.

At state 803, the computer 51 asks the device 52 whether the device driver is available from the Internet by using the Internet Website address for the device driver. If it is decided that the device driver is available as shown in FIG. 5, the computer 51 gets access to the address. The sequence goes to state 804 where the computer 51 automatically downloads the device driver thereto from the vendor's Website through the Internet. At state 805, the computer 51 transfers the downloaded device driver to the device 52 to update it. These states 804 and 805 can be integrated into one state. Then, at state 806, the computer 51 decides that the device driver is updated in the device 52. If at state 803 it is decided that the device driver is not available, the procedure goes to state 808 and the computer 51 decides that the device driver is unavailable from the Internet.

Accordingly, since the computer 51 can download the device driver regularly or at the request of the user, the device driver is updated quite often and the latest version of the device driver may be stored in the device 52. The latest version of the device driver will always be available to the user.

FIG. 9 is a flowchart illustrating the operation of the system when a host is connected to a device, with respect to updating an application, in accordance with the invention. The flowchart shown in FIG. 9 is identical to that shown in FIG. 8, except that FIG. 8 is directed to the device driver while FIG. 9 to the application. States 900-908 correspond to states 800-808, respectively. Thus, a detailed explanation of FIG. 9 is not necessary.

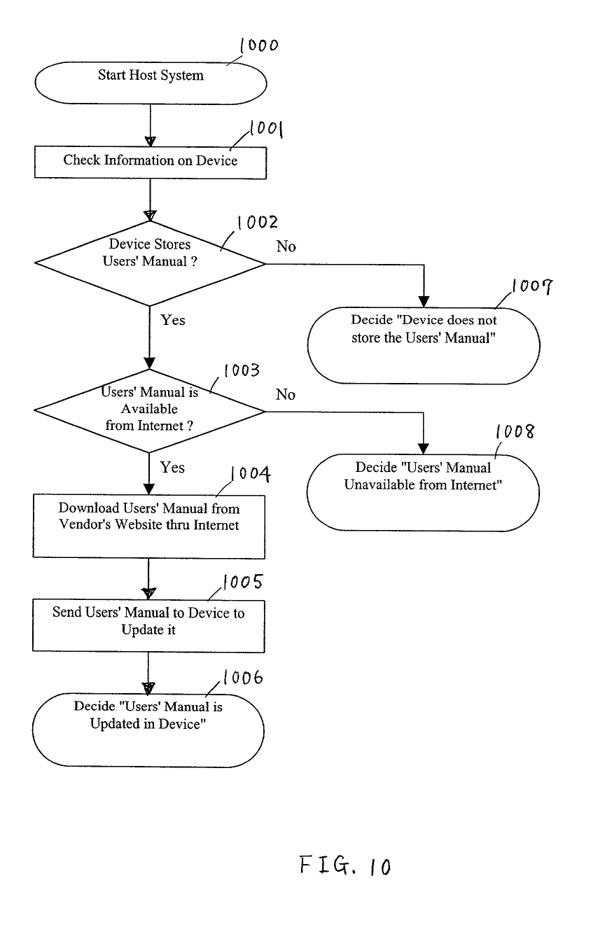

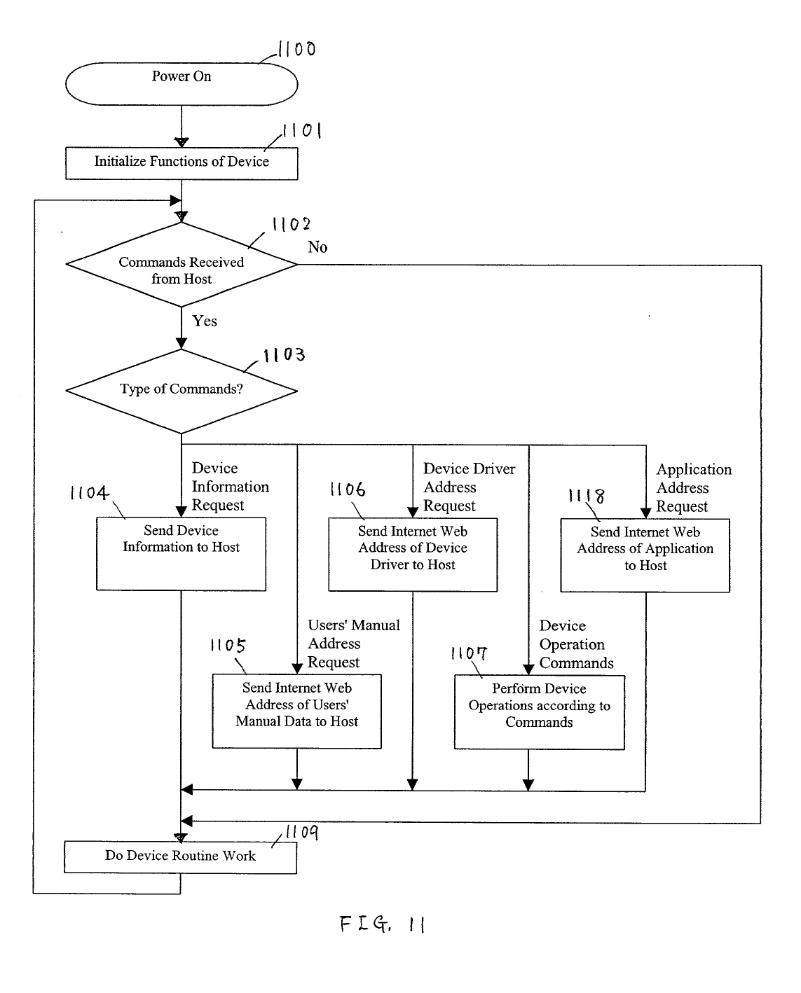

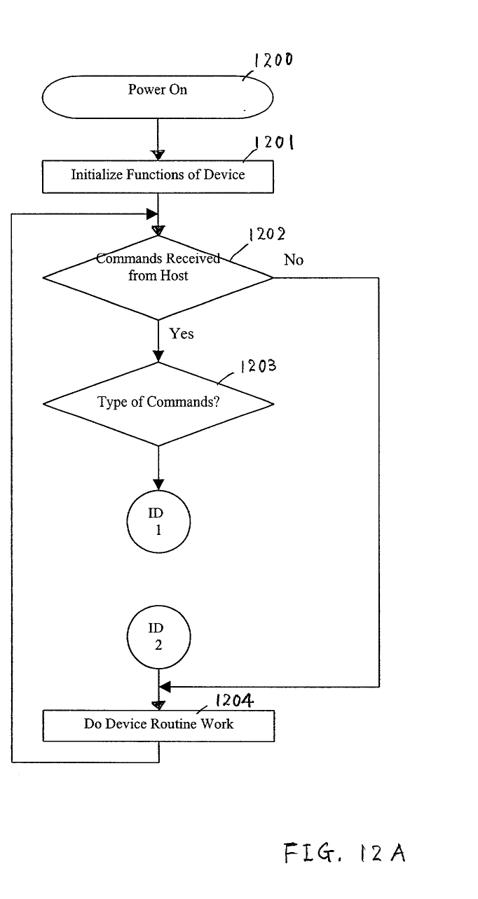

FIG. 10 is a flowchart illustrating the operation of the system when a host is connected to a device, with respect to updating user's manual, in accordance with the invention. The flowchart shown in FIG. 10 is identical to that shown in FIG. 8, except that FIG. 8 is directed to the device driver while FIG. 10 to the user's manual. States 1000-1008 correspond to states 800-808, respectively. Thus, a detailed explanation of FIG. 10 is not necessary.

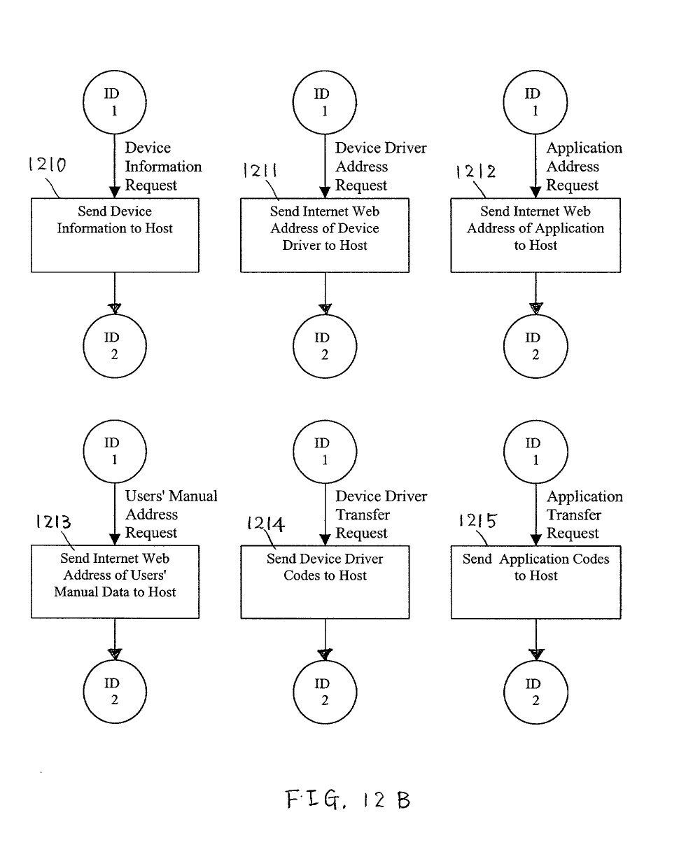

FIG. 11 is a flowchart illustrating the operation of a firmware program controlling a device, as one of the examples of a device control logic, for storing only Internet Website addresses shown in FIG. 4 in accordance with the invention. First, at state 1100, the power of the device 42 is turned on. Then, at state 1101, the functions of the device 42 are initialized. At state 1102, it is decided whether commands are received from the host 41. If it is decided that they are, the sequence goes to state 1103 where it is asked what type the commands are.

If the type is a device information request, the sequence goes to state 1104 where the device 42 sends the device information to the host 41. If the type is a user's manual address request, at state 1105 the device 42 sends an Internet Website address of user's manual data to the host 41. If the type is a device driver address request, at state 1106 the device 42 sends an Internet Website address of device driver to the host 41. When the type is device operation commands, the sequence goes to state 1107 where the device 42 performs device operations according to the commands. If the type is an application address request, at state 1108 the device 42 sends an Internet Website address of application to the host 41.

After states 1104-1108, or when at state1102 it is decided that commands are not received, the sequence proceeds to 1109 where the device 42 does its routine work. Then, the sequence goes back to state 1102.

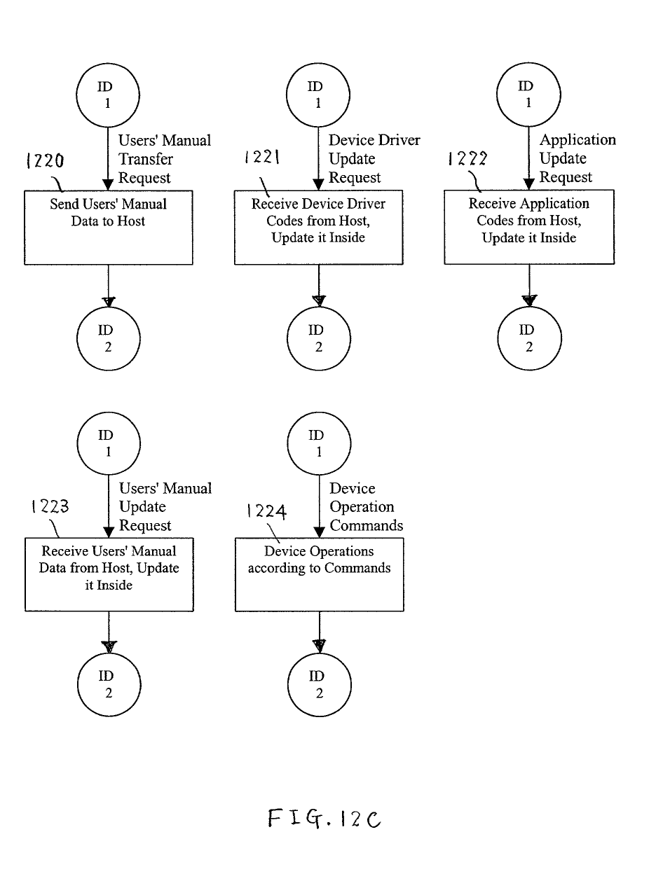

FIG. 12 is a flowchart illustrating the operation of a firmware controlling device for storing the Internet Website addresses, device driver, application, and user's manual shown in FIG. 5 in accordance with the invention. FIG. 12 comprises FIGS. 12A-12C.

First, at state 1200, the power of the device 52 is powered on. Then, at state 1201, the functions of the device 42 are initialized. When the device 42 is, for example, a printer, initialization is associated with adjusting a home position of a head, or clearing a volatile memory. At state 1202, it is decided whether commands are received from the host 51. If it is decided that they are, the sequence goes to state 1203 where it is asked what type the commands are. If at state 1202 it is decided that the commands are not received, the sequence proceeds to state 1204 where the device 52 does its routine work, such as checking remaining volume of ink, when the device 52 is a printer. After state 1204, the sequence returns to state 1202.

After being asked the type of commands at state 1203, the sequence goes to one of states 1210-1215 and 1220-1224 via the symbols ID 1, depending on the type. States 1210-1213 and 1224 are identical to states 1104, 1106, 1108, 1105, and 1107, respectively. Their explanations may be omitted. The other types of commands are a group of transfer request—a device driver transfer request, an application transfer request, and a user's manual transfer request, and a group of update request—a device driver update request, an application update request, and a user's manual update request.

When the type of commands is a device driver transfer request, at state 1214 the device 52 sends the device driver codes to the host 51. One example of the codes is shown in Appendix 2. The example uses the C++ program language. Of course, other languages and codes may implement the described function. State 1214 corresponds to state 606 in FIG. 6. Then, the sequence goes further to state 1204 through the symbol ID 2. The rest of the transfer requests can be described the same way. When the type of commands is a device driver update request, at state 1221 the device 52 receives the device driver codes from the host 51 and updates the device driver therein. State 1221 corresponds to state 805 in FIG. 8. The sequence proceeds to state 1204 through the symbol ID 2. The rest of the update requests can be described alike.

As can be understood from the description above, the embodiments of the invention enable the host automatically to obtain the desired data or software from the device or data source designated by the device, without requiring a user's instructions or operations, when the host is connected to the device. The user does not have to manually load media (CD-ROMs, DVD (Digital Versatile Discs)-ROMs, floppy discs) in the host and install the software stored in the media for the device. Therefore, time and labor can be saved.

Since user's manual and software for the device are stored in the device, the user does not need prepare for space to keep them or look for them when need arises. The manual and software can be retrieved for use for a short period of time. Space and time can be saved.

Since the latest version of software can be downloaded through the Internet regularly or at the request of the user, making full use of the software may be guaranteed. This also contributes to saving time and labor.

Although described above in connection with the particular embodiments of the present invention, it should be understood that the descriptions of the embodiments are illustrative of the invention and are not intended to be limiting. Various modifications and applications may occur to those skilled in the art without departing from the true spirit and scope of the invention as defined in the appended claims.

Appendix 1
USB Device Request (Vendor Specific Request)

Description

Data Transfer Direction: Device to Host
Type: Vendor
Recipient: Device
Request Code: GET_SPECIAL_DESCRIPTORS (0x06)

Request Codes:

0xC0
0x06
0x00
0x00
0x00
0x00
0x00
0x00
0x18

Return Data Format:

| | |
|---|---|
| Byte 0-3: | Size of the Device Driver (if 0, not available) |
| Byte 4-7: | Size of the Application (if 0, not available) |
| Byte 8-11: | Size of the Users Manual (if 0, not available) |
| Byte 12-15: | Length of the Internet Web Site Address of the Device |
| | Driver (if null, not available) |
| Byte 16-19: | Length of the Internet Web Site Address of the |
| | Application (if null, not available) |
| Byte 20-23: | Length of the Internet Web Site Address of the Users |
| | Manual (if null, not available) |

Appendix 2
static char rcsid[] =“$Id: joliet.c,v 1.14 1999/03/07 17:41:19 eric Exp $”;
#include “config.h”
#include “mkisofs.h”
#include “iso9660.h”
#include <stdlib.h>
#include <time.h>
#ifdef USE_LIBSCHILY
#include <standard.h>
#endif
static int jpath_table_index;
static struct directory ** jpathlist;
static int next_jpath_index = 1;
static int sort_goof;
static int generate_joliet_path_tables_{——}PR((void));
static int DECL(joliet_sort_directory, (struct directory_entry ** sort_dir));
static void DECL(assign_joliet_directory_addresses, (struct directory * node));

| | |
|---|---|
| static int jroot_gen | _{——}PR((void)); |
| /* | |
| * Function: | convert_to_unicode |
| * | |
| * Purpose: | Perform a ½ assed unicode conversion on a text |
| * | string. |
| * | |
| * Notes: | |
| */ | |

static void FDECL3(convert_to_unicode, unsigned char *, buffer, int, size, char *,
source )
{
unsigned char * tmpbuf;
int i;
int j;
/*
* If we get a NULL pointer for the source, it means we have an inplace
* copy, and we need to make a temporary working copy first.
*/
if( source == NULL)
{
tmpbuf = (u_char *) e_malloc(size);
memcpy( tmpbuf, buffer, size);
}
else

{
tmpbuf = (u_char *)source;
}

/*
* Now start copying characters. If the size was specified to be 0, then
* assume the input was 0 terminated.
*/
j = 0;

| | |
|---|---|
| for(i= 0; (i+ 1) < size ; i += 2, j++) | /* Size may be odd !!! */ |

| | |
|---|---|
| { | |
| buffer[i] | = 0; |

/*
* JS integrated from: Achim_Kaiser@t-online.de
*
* Let all valid unicode characters pass through (assuming ISO-8859-1).
* Others are set to ‘_’.
*/
if( tmpbuf[j] != 0 &&

(tmpbut[j] <= 0x1f || (tmpbuf[j] >= 0x7F && tmpbuf[j] <= 0xA0)) )

| | |
|---|---|
| { | |
| buffer[i+1] | =‘_’; |
| } | |

else

{
switch(tmpbuf[j])

{
case ‘*’:
case ‘/’:
case ‘:’:
case ‘;’:
case ‘?’:
case ‘\\’:

/*
* Even Joliet has some standards as to what is allowed in a pathname.
* Pretty tame in comparison to what DOS restricts you to.
*/

| | |
|---|---|
| buffer[i+1] | =‘_’: |
| break; | |

default:

| | |
|---|---|
| buffer[i+1] | =tmpbuf[j]; |
| break; | |

}

}

}

What is claimed is:

1. A method of transferring data or software to a host from or through a device with a memory, the method comprising:
storing in the memory at least one data or software and at least one address that designates its corresponding data source;
connecting the host to the device;
allowing the host to inquire of the device whether or not a desired data or software is stored in the memory; and
if so, uploading the desired data or software to the host from the memory.

2. The method of claim 1, further comprising:
if the desired data or software is not stored in the memory, allowing the host to inquire of the device whether or not the desired data or software is available from the data source via the address; and
if so, downloading the desired data or software to the host from the data source.

3. The method of claim 1, wherein the act of allowing the host to inquire of the device whether or not a desired data or software is stored in the memory is preceded by the act of allowing the host to inquire of itself whether or not the desired data or software is stored therein.

4. The method of claim 2, further comprising transferring the downloaded data or software to the memory.

5. The method of claim 1, wherein the host is a personal computer.

6. The method of claim 1, wherein the device is a printer, digital camera, scanner, or CD/DVD drive.

7. The method of claim 1, wherein the memory is non-volatile.

8. The method of claim 1, wherein the data is a user's manual.

9. The method of claim 1, wherein the software is a device driver and/or an application.

10. The method of claim 1, wherein the act of connecting the host and the device is carried out by a USB, IEEE 1394, SCSI, or standard protocol.

11. The method of claim 1, wherein the data source is found via an Internet Website.

12. A method of transferring data or software to a host from or through a device with a memory, the method comprising:
storing in the memory at least one data or software and at least one address that designates its corresponding data source;
connecting the host to the device;
allowing the host to inquire of the device driver whether or not a desired data or software is available form the data source via the address; and
if so, downloading the desired data or software to the host from the data source.

13. The method of claim 12, further comprising transferring the downloaded data or software to the memory for update.

14. The method of claim 12, wherein the act of allowing the host to inquire of the device driver whether or not a desired data or software is available form the data source through the address is preceded by the act of allowing the host to inquire of the device whether or not the desired data or software is stored in the memory.

15. A method of transferring data or software to a host through a device with a memory, the method comprising:
storing in the memory at least one address that designates its corresponding data source;
connecting the host to the device;
allowing the host to inquire of the device whether or not a desired data or software is available from the data source via the address; and
if so, downloading the desired data or software to the host from the data source.

16. The method of claim 15, wherein the data source is found via the Internet Website.

17. A system for transferring data or software, comprising:
a host; and
a device, having a memory, connected to the host, wherein the memory stores at least one data or software and at least one address that designates its corresponding data source;
whereby the host uploads the desired data or software thereto from the memory.

18. The method of claim 17, wherein uploading by the host is executed after the host inquires of the device whether or not a desired data or software is stored in the memory, and confirms so.

19. The method of claim 17, wherein the host is a personal computer.

20. The method of claim 17, wherein the device is a printer, digital camera, scanner, or CD/DVD drive.

21. The method of claim 17, wherein the data is a user's manual.

22. The method of claim 17, wherein the software is a device driver and/or an application.

23. A system for transferring data or software, comprising:
a host; and
a device, having a memory, connected to the host, wherein the memory stores at least one data or software and at least one address that designates its corresponding data source;
whereby the host downloads the desired data or software thereto from the data source.

24. The method of claim 23, wherein downloading by the host is executed after the host inquires of the device whether or not a desired data or software is available from the data source, and confirms so.

25. The method of claim 23, wherein the host is a personal computer.

26. The method of claim 23, wherein the device is a printer, digital camera, scanner, or CD/DVD drive.

27. The method of claim 23, wherein the data is a user's manual.

28. The method of claim 23, wherein the software is a device driver and/or an application.

29. A system for transferring data or software, comprising:
a host; and
a device, having a memory, connected to the host, wherein the memory stores at least one address that designates its corresponding data source;
whereby the host inquires of the device whether or not a desired data or software is available from the data source via the address, and if so, downloads the desired data or software thereto from the data source.
